(19) United States
(12) Patent Application Publication
(10) Pub. No.: US 2026/0183683 A1
(43) Pub. Date: Jul. 2, 2026

(54) SELECTIVE COBALT EXTRACTION FROM NICKEL AND MANGANESE SOLUTIONS

(71) Applicant: ASCEND ELEMENTS, INC., Westborough, MA (US)

(72) Inventors: Christophe Henri Robert Duhayon, Montreal (CA); Atefeh Azizitorghabeh, Kingston (CA)

(21) Appl. No.: 19/003,278

(22) Filed: Dec. 27, 2024

Related U.S. Application Data
(60) Provisional application No. 63/739,209, filed on Dec. 27, 2024.

(51) Int. Cl. B01D 11/04; C01G 45/00; C01G 53/00; H01M 10/54

(52) U.S. Cl. CPC B01D 11/0492; B01D 11/0488; C01G 45/00; C01G 53/00; H01M 10/54; C01P 2006/40

(57) ABSTRACT

Methods of recovering nickel and manganese salts are disclosed. The method includes removing one or more impurities from an aqueous leach solution including cobalt, manganese, and nickel salts to produce a purified aqueous solution including the cobalt, manganese, and nickel salts. The method includes extracting the cobalt salt from the purified aqueous solution in a first liquid-liquid extraction step using an organic extractant to produce an aqueous raffinate solution including the nickel and manganese salts and a first loaded organic solution including the cobalt salt.

### CROSS-REFERENCE TO RELATED APPLICATIONS

This application claims priority under 35 U.S.C. § 119(e) to U.S. Provisional Patent Application Ser. No. 63/739,209, titled “SELECTIVE COBALT SALT EXTRACTION FROM NICKEL, MANGANESE, AND COBALT SALT SOLUTIONS,” filed Dec. 27, 2024, the entire contents of which is incorporated herein by reference for all purposes.

### BACKGROUND

Lithium-ion (Li-ion) batteries are a preferred chemistry for secondary, e.g., rechargeable, batteries in high discharge applications such as electrical vehicles (EVs) and power tools where electric motors are called upon for rapid acceleration. Li-ion batteries include a charge material, conductive powder and binder applied to or deposited on a current collector, typically a planar sheet of copper or aluminum. The charge material includes anode material, typically graphite or carbon, and cathode material, which includes a predetermined ratio of metals such as lithium, nickel, manganese, cobalt, aluminum, iron, and phosphorous, defining a so-called “battery chemistry” of the Li-ion cells. The preferred battery chemistry varies between vendors and applications, and recycling efforts of Li-ion batteries typically adhere to a prescribed molar ratio of the battery chemistry in recycled charge material products. Industry trends are moving towards a more nickel-rich chemistry, often preferring nickel, manganese, and cobalt (NMC) in molar ratios of N:M:C such as 5:3:2 (532), 6:2:2 (622), 8:1:1 (811), and 99:0.5:0.5 (9.5.5). It has been observed that as numerous electric vehicles attain the end of their service life, a potentially large recycling stream results from the charge material that might otherwise generate a harmful waste source.

### SUMMARY

A method disclosed herein recovers a mixture of a nickel salt and a manganese salt, e.g., from cathode active materials in a recycling stream of end-of-life batteries. One or more impurities from an acidic aqueous leach solution comprising cobalt, manganese, and nickel salts are removed to produce a purified aqueous solution comprising the cobalt, manganese, and nickel salts. The cobalt salt is extracted from the purified aqueous solution in a first liquid-liquid extraction step with an organic extractant. The organic solution produced is a loaded organic solution comprising the cobalt salt. The aqueous raffinate solution from the first liquid-liquid extraction step comprises the nickel salt and the manganese salt. The nickel salt and the manganese salt may be removed from the aqueous raffinate solution to be used in the production of Co-free cathode active materials. The loaded organic solution including the cobalt salt may be further processed to recover the cobalt salt, using, for example, one or more additional liquid-liquid extractions.

Systems of this disclosure are configured to recover nickel salts and manganese salts, e.g., from cathode active materials in a recycling stream of end-of-life batteries. Systems for recovering nickel salts and manganese salts include an impurity removal stage constructed and arranged to remove one or more impurities from an acidic aqueous leach solution comprising cobalt, manganese, and nickel salts to produce a first purified aqueous solution comprising the cobalt, manganese, and nickel salts. Systems for recovering nickel salts and manganese salts include a first extraction stage constructed and arranged to extract the cobalt salt from the purified aqueous solution to produce an aqueous raffinate solution comprising the nickel and manganese salts and a loaded organic solution comprising the cobalt salt.

### BRIEF DESCRIPTION OF THE DRAWINGS

The foregoing and other features will be apparent from the following description of particular embodiments disclosed herein, as illustrated in the accompanying drawings in which like reference characters refer to the same parts throughout the different views. The drawings are not necessarily to scale, emphasis instead being placed upon illustrating the principles of the invention. For purposes of clarity, not every component may be labeled in every drawing. In the drawings:

FIG. 1 illustrates a flow chart of a method for the recovery of nickel and manganese salts, in accordance with an embodiment disclosed herein; and

FIG. 2 illustrates the selectivity of metal salts in an organic extractant solution comprising a dialkylphosphinic acid as a function of equilibrium pH.

### DETAILED DESCRIPTION

This disclosure is directed to systems and methods for the recovery of nickel and manganese salts, e.g., from a nickel- and manganese-containing, e.g., a nickel- and manganese-rich, cathode material in a recycling stream of end-of-life batteries. Lithium-ion batteries contain valuable precious metals which would go to waste when the batteries are spent and discarded. With the rising use of lithium-ion batteries, the recovery of precious metals from spent lithium-ion batteries has become an important industry.

Typically, end-of-life lithium-ion batteries are dismantled, crushed, or shredded to form a granular mass of battery materials (including cathode materials, anode materials, current collectors, electrolytes, etc.), often referred to as “black mass” which is used for further recycling. Current lithium-ion battery recycling efforts are primarily focused on recovering the base metals cobalt and lithium from lithium cobalt oxide cathodes. However, there are many other types of cathode materials used in lithium-ion batteries. A significant portion of these cathode materials include other base metals such as nickel and manganese. Conventional recycling methods do not adequately handle the recycling of different types of lithium-ion battery cathode materials and fail to sufficiently address the extraction of these other metals. Many existing recovery processes have numerous extraction, scrubbing, and stripping stages, increasing costs and time to produce suitable materials for battery production.

Further, black mass, especially those derived collectively from different types of lithium-ion batteries, contains many types of impurities. Failing to effectively remove them adversely affects the purity of metals recovered by recycling. Present efforts of impurity removal involve numerous steps requiring many reactors and filters. Not only does this lengthen the entire recycling process and increase costs, but with each reactor or filter, valuable material is lost, resulting in a severe reduction in the amounts of base metals available for recovery.

Thus, there exists a need for a lithium-ion battery recycling process which can better handle the removal of impurities in black mass, especially that derived collectively from different types of lithium-ion batteries. There also exists an associated need to remove impurities in a more efficient way that requires less equipment and results in less reduction in the amounts of base metals available for recovery.

Depicted herein is an example method and approach for recycling batteries containing, inter alia, nickel, manganese, and cobalt. Lithium-ion batteries have been used for many applications and are becoming more and more important for electronic devices, electric vehicles, and energy storage systems. High nickel ternary or quaternary batteries are gathering more attention due the higher energy capacity and lower raw materials cost. The high nickel batteries often reach their end of life within 8-15 years, and they will comprise the bulk of spent lithium-ion batteries in the future. Front-end material recovery methods from black mass are becoming more important as a way to recycle spent batteries and as a source for battery cathode materials.

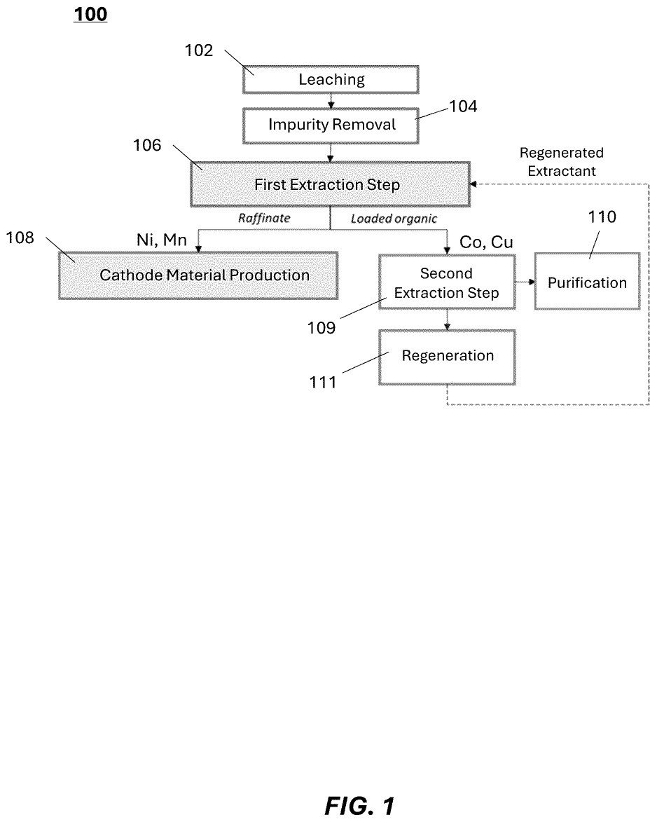

FIG. 1 is a flow diagram of an embodiment of a method for the recovery of nickel and manganese salts, e.g., from an acidic aqueous leach solution comprising cobalt, manganese, and nickel salts. With reference to FIG. 1, in recovery method 100, leaching 102 is performed on black mass to separate the recoverable materials from the black mass. The acidic aqueous leach solution is prepared by leaching metal salts from a granular black mass, such as one that results from crushed battery materials including cathode materials and anode materials, using an aqueous solution that includes an acid, such as sulfuric acid, hydrochloric acid, nitric acid, acetic acid, boric acid, oxalic acid, formic acid, or any other suitable organic or inorganic acid and may further include an optional oxidizing agent or reducing agent. In a specific embodiment, an aqueous acid solution such as sulfuric acid and water, optionally including hydrogen peroxide, and the black mass are combined to dissolve base metals present within the crushed battery materials into the aqueous phase.

The acidic aqueous leach solution includes the metals of interest, e.g., nickel, manganese, and cobalt salts, and one or more impurities that can impact the recovery of the metal salts of interest. To remove some or all of these impurities, removal step 104 occurs in which insoluble compounds of the impurities are formed using a pH adjustment of the acidic aqueous leach solution. For example, an increase in the pH of the acidic aqueous leach solution using a water-soluble base, such as NaOH, NH₄OH, (NH₄)₂CO₃, or another water-soluble base, can facilitate precipitation of insoluble hydroxide compounds of the impurities, such as iron, aluminum, and copper, that can subsequently be removed, such as by filtration, to produce a purified aqueous solution comprising the cobalt, manganese, and nickel salts. In some embodiments, a pH of the purified aqueous solution is acidic, e.g., having a pH of from about 3 to 5.

With continued reference to FIG. 1, a method of recovering nickel and manganese salts includes first liquid-liquid extraction step 106 configured to extract the cobalt salt from the purified aqueous solution. First liquid-liquid extraction step 106 is a liquid-liquid extraction process using a liquid organic extractant solution that is substantially immiscible with the purified aqueous solution. When the purified aqueous solution and the organic extractant solution are combined, a loaded organic solution including extracted cobalt salt is produced. At least one of the impurities may also be extracted, such as copper salts. The raffinate solution produced is an aqueous solution comprising the nickel and manganese salts.

Without wishing to be bound by any particular theory, organic extractant solutions useful for liquid-liquid extractions disclosed herein comprise an organic extractant having functionalities with affinity for the metal salts in the aqueous phase and with high selectivity for specific metal ions, depending on the pH of the aqueous phase. For example, the organic extractant may be a dialkylphosphinic acid, e.g., R₁R₂PO₂H where R₁ and R₂ are alkyl groups. In some cases, the dialkylphosphinic acid is a thiophosphinic acid, e.g., R₁R₂P(═S)OH. As a non-limiting example, the organic extractant may be di(2,4,4 trimethylpentyl)monothiophosphinic acid, i.e., CYANEX® 302 extractant. When used as part of the organic extractant solution, the dialkylphosphinic acid may be present in a concentration of about 10% to about 20% w/w or v/v in a solution. The balance of the organic extractant solution may include an organic diluent or one or more diluents in which the dialkylphosphinic acid is soluble. For example, a paraffinic diluent, such as Shell GTL solvent, may be used.

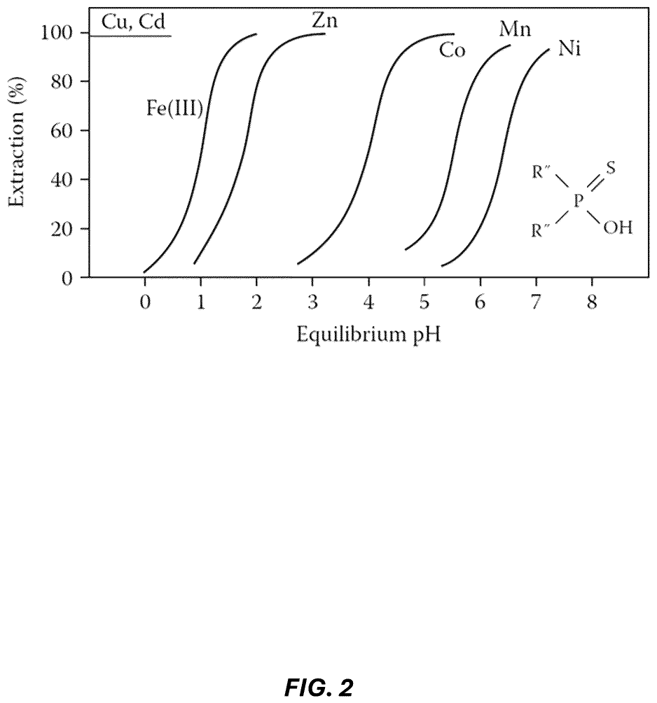

As illustrated in FIG. 2, the selectivity of various metal salts in a solution of a first organic extractant solution comprising a dialkylphosphinic acid is a function of the equilibrium pH of the extraction solution. In FIG. 2, cobalt salts can be extracted within a relatively narrow pH window, with manganese and nickel salts being extracted at a relatively higher pH. In some embodiments, during the first liquid-liquid extraction step, the purified aqueous solution has an equilibrium pH of less than 5, and, in specific embodiments, a pH of greater than 0, such as greater than 2. For example, the equilibrium pH during the first liquid-liquid extraction step is preferably from about 3 to about 5. Specific ranges could be determined by one of ordinary skill in the art in view of the information illustrated in FIG. 2.

If necessary, the pH of the purified aqueous solution can be increased or decreased in order to achieve the desired equilibrium pH during the first liquid-liquid extraction step. For example, in some embodiments, a basic pH adjusting compound can be added to the purified aqueous solution. The pH adjusting compound can be a water-soluble base, such as NaOH, NH₄OH, (NH₄)₂CO₃, or another water-soluble base. In some embodiments, a water-soluble acid, such as a weak acid or a dilute acid, may be used to lower the pH. Suitable acids can be any of those described above relating to the acid of the acidic aqueous leach solution.

Once the target equilibrium pH of the purified aqueous solution is achieved, the organic extractant solution and the purified aqueous solution can be combined in a fixed ratio of organic to aqueous phases, i.e., O:A ratio, to begin the first liquid-liquid extraction step. The specific ratio will depend on the concentration and type of metals to be extracted. Example O:A ratios include from about 1:1 to about 3:1, such as 2:1.

The efficiency of the first liquid-liquid extraction step can also be a function of the extraction temperature. In some embodiments, the first liquid-liquid extraction step is performed at a temperature from about 40° C. to about 60° C. In certain embodiments, the first liquid-liquid extraction step is performed at a temperature of about 50° C.

With continued reference to FIG. 1, first liquid-liquid extraction step 106 produces an aqueous raffinate solution comprising nickel and manganese salts and a loaded organic solution comprising the cobalt salt. The metal salts in each of these solutions can either be used in solution or can be recovered using a series of extraction steps.

For example, as shown in FIG. 1, the loaded organic solution can be used as a feed solution for second liquid-liquid extraction step 109 using an aqueous extractant solution to produce an enriched aqueous cobalt salt solution and an organic waste solution comprising the organic extractant. Thus, the metal salts in the organic phase are removed and transferred to an aqueous phase. For example, the second liquid-liquid extraction step can be performed by using an acidic stripping solution, e.g., an aqueous solution of sulfuric acid, e.g., 2 M sulfuric acid, to transfer the cobalt salt in the organic phase back into an aqueous phase. The enriched aqueous cobalt salt solution can be further processed to produce purified cobalt salt for industrial purposes or other relevant uses requiring purified cobalt salts at purification step 110. The organic waste solution comprising the organic extractant can be further processed in regeneration step 111 to recover the organic extractant such that it can be reused in first extraction step 106. Regeneration step 111 may use an acidic regenerant solution, e.g., an aqueous solution of sulfuric acid, e.g., 5 M sulfuric acid, to remove any residual metal salts from active sites of the organic extractant. Following regeneration of the organic extractant, the regenerated organic extractant can be washed to remove the acidic regenerant solution, and the pH of the regenerated organic extractant can be adjusted.

With continued reference to FIG. 1, the aqueous raffinate solution comprising the nickel and manganese salts from first extraction step 106 can be used in the production of cathode active materials at step 108. In the production of cathode active materials, the nickel salt and the manganese salt can be used together to form a cathode material precursor which, when combined with a lithium compound, can be sintered to form a nickel and manganese containing cathode material. That is, no additional separation of the nickel salt from the manganese salt is needed, such as with one or more additional liquid-liquid extraction steps. Since the aqueous raffinate solution is substantially free of cobalt, this solution is most useful in the preparation of a cobalt-free nickel-manganese cathode active material precursor. In some embodiments, the ratio of the nickel salt to the manganese salt, i.e., a Ni-to-Mn molar ratio, present in the aqueous raffinate solution may be deficient in either nickel or manganese to be suitable for the production of cathode active materials. In cases where this occurs, the ratio of Ni-to-Mn can be adjusted by the addition of a nickel salt and/or a manganese salt to bring the ratio to the appropriate range for cathode active material production. In further embodiments, the nickel salt and the manganese salt are co-precipitated from the aqueous raffinate solution for use in the production of cathode active materials. Co-precipitation can be performed using methods known in the art, such as by the addition of a hydroxide, carbonate, or other basic ion to increase the pH of the aqueous raffinate solution.

In accordance with an embodiment, there is provided a system for recovering nickel salts and manganese salts. The system includes an impurity removal stage constructed and arranged to remove one or more impurities from an acidic aqueous leach solution comprising cobalt, manganese, and nickel salts to produce a purified aqueous solution comprising the cobalt, manganese, and nickel salts. The system further includes a first extraction stage constructed and arranged to remove the cobalt salt from the purified aqueous solution to produce an aqueous raffinate solution comprising the nickel and manganese salts and a loaded organic solution comprising the cobalt salt.

The phraseology and terminology used herein is for the purpose of description and should not be regarded as limiting. As used herein, the term “plurality” refers to two or more items or components. The terms “comprising,” “including,” “carrying,” “having,” “containing,” and “involving,” whether in the written description or the claims and the like, are open-ended terms, i.e., to mean “including but not limited to.” Thus, the use of such terms is meant to encompass the items listed thereafter, and equivalents thereof, as well as additional items. Only the transitional phrases “consisting of” and “consisting essentially of,” are closed or semi-closed transitional phrases, respectively, with respect to the claims. Use of ordinal terms such as “first,” “second,” “third,” and the like in the claims to modify a claim element does not by itself connote any priority, precedence, or order of one claim element over another or the temporal order in which acts of a method are performed, but are used merely as labels to distinguish one claim element having a certain name from another element having a same name (but for use of the ordinal term) to distinguish the claim elements.

Having thus described several aspects of at least one embodiment, it is to be appreciated that various alterations, modifications, and improvements will readily occur to those skilled in the art. Any feature described in any embodiment may be included in or substituted for any feature of any other embodiment. Such alterations, modifications, and improvements are intended to be part of this disclosure and are intended to be within the scope of the invention. Accordingly, the foregoing description and drawings are by way of example only.

Those skilled in the art should appreciate that the parameters and configurations described herein are exemplary and that actual parameters and/or configurations will depend on the specific application in which the disclosed methods and materials are used. Those skilled in the art should also recognize or be able to ascertain, using no more than routine experimentation, equivalents to the specific embodiments disclosed.

What is claimed is:

1. A method of recovering nickel and manganese salts, comprising:
removing one or more impurities from an acidic aqueous leach solution comprising cobalt, manganese, and nickel salts to produce a purified aqueous solution comprising the cobalt, manganese, and nickel salts; and
extracting the cobalt salt from the purified aqueous solution in a first liquid-liquid extraction step using an organic extractant solution comprising an organic extractant to produce an aqueous raffinate solution comprising the nickel and manganese salts and a loaded organic solution comprising the cobalt salt.

2. The method of claim 1, wherein the acidic aqueous leach solution is prepared by leaching metal salts from a granular mass of crushed battery materials including cathode materials and anode materials with an aqueous solution comprising at least one acid.

3. The method of claim 2, wherein the aqueous solution further comprises hydrogen peroxide.

4. The method of claim 1, wherein removing the one or more impurities from the leach solution comprises precipitation by pH adjustment.

5. The method of claim 4, wherein the pH adjustment comprises a pH increase of the aqueous leach solution using a water-soluble base.

6. The method of claim 4, wherein the pH adjustment results in precipitation of insoluble hydroxide compounds of the one or more impurities removable by filtration.

7. The method of claim 1, wherein the organic extractant is a dialkylphosphinic acid extractant.

8. The method of claim 7, wherein the dialkylphosphinic acid is dissolved in an organic diluent to a concentration of about 10% to about 20%.

9. The method of claim 7, wherein the dialkylphosphinic acid is a thiophosphinic acid.

10. The method of claim 7, wherein the dialkylphosphinic acid is di(2,4,4-trimethylpentyl) monothiophosphinic acid.

11. The method of claim 1, wherein, during the first liquid-liquid extraction step, the purified aqueous solution has an equilibrium pH of less than 5.

12. The method of claim 11, wherein the equilibrium pH is from about 3 to about 4.

13. The method of claim 1, wherein the first liquid-liquid extraction step occurs at a temperature of from about 40° C. to about 60° C.

14. The method of claim 1, further comprising performing a second liquid-liquid extraction step on the loaded organic solution to produce an enriched aqueous cobalt salt solution and an organic waste solution comprising the organic extractant.

15. The method of claim 14, further comprising regenerating the organic extractant with an acidic regenerant.

16. The method of claim 15, wherein the acidic regenerant solution comprises sulfuric acid.

17. The method of claim 14, further comprising forming a cathode active material from the nickel and manganese salts in the aqueous raffinate solution.

18. The method of claim 17, wherein the nickel salt and the manganese salt are co-precipitated out of the aqueous raffinate solution for forming the cathode active material.

19. The method of claim 17, wherein a ratio of nickel to manganese in the aqueous raffinate solution is adjusted for forming the cathode active material.

20. A system for recovering nickel and manganese salts, comprising:
an impurity removal stage constructed and arranged to remove one or more impurities from an aqueous leach solution comprising cobalt, manganese, and nickel salts to produce a purified aqueous solution comprising the cobalt, manganese, and nickel salts; and
an extraction stage constructed and arranged to extract the cobalt salt from the purified aqueous solution to produce an aqueous raffinate solution comprising the nickel and manganese salts and a loaded organic solution comprising the cobalt salt.
